(19) United States
(12) Patent Application Publication
(10) Pub. No.: US 2006/0254803 A1
(43) Pub. Date: Nov. 16, 2006

(54) Ornamental computer network cables

(76) Inventors: Albertina Hurst Dorffler, Oakton, VA (US); John M. Dorffler, Oakton, VA (US)

Correspondence Address: LITMAN LAW OFFICES, LTD, PO BOX 15035, CRYSTAL CITY STATION, ARLINGTON, VA, 22215, US

(21) Appl. No.: 11/137,522

(22) Filed: May 26, 2005

(51) Int. Cl. H01B 11/02

(52) U.S. Cl. 174/115

(57) ABSTRACT

The ornamental computer network cable is used to rapidly visually identify electronic installation cables. The cable has a series of colored, textured beads strung along the length of the cable. The cable utilizes RJ45-type connectors at each end for networking communication. The color and texture patterns may be used to identify the type of data carried by the cable, whether the data is critical to some function, whether the cable is active, the source or owner of the information, and other characteristics. The beads may be separate, or may be fused together into a solid, colored, textured casing.

### BACKGROUND OF THE INVENTION

1. Field of the Invention

The present invention relates to a method and apparatus for identification of cables used in electronics installations. More particularly, the invention relates to color and texture coordinated casings for electronic cables used in information technologies and related fields.

2. Description of the Related Art

Informational hubs at many large companies and government agencies are becoming more complex as the amount of information that passes through them increases. The hubs routinely use a large number of interconnected cables passing to and from various electronic components. When the hubs, servers, racks, patches, etc., are reconfigured, or when regular maintenance is performed on them, the cables are often disconnected from some locations and reconnected in others.

Currently, these cables often have a single, colored insulating coating that provides identification of the type of cable. Some cables may have a small amount of indicia printed or secured to the coating to provide an additional identification, although the indicia must be sized to fit on the thin cables, reducing the ability of this indicia to be seen and recognized at a glance.

However, during the reconfiguration or maintenance of these cables, the user must identify the type of data passing through the cable, the criticality of that data, whether the cable is active, and other important information, before moving any of the connections. These multiple bits of information should be readily visible and easily recognizable, due to the large number of cables used and the small amount of time that is often available to do the work. Thus, ornamental computer network cables solving the aforementioned problems are desired.

### SUMMARY OF THE INVENTION

The ornamental computer network cable is used to rapidly visually identify electronic installation cables. The cable comprises a series of colored, textured beads strung along the length of the cable. The color and texture patterns may be used to identify the type of data carried by the cable, whether the data is critical to some function, whether the cable is active, the source or owner of the information, and other characteristics. The beads may be separate, or may be fused together into a solid colored, textured casing. Additionally, colored or textured boots may be used, in conjunction with the beads, to protect and identify the connectors attached to the end of the cables.

These and other features of the present invention will become readily apparent upon further review of the following specification and drawings.

### BRIEF DESCRIPTION OF THE DRAWINGS

FIG. 1 is a perspective view of a beaded network cable according to the present invention.

FIG. 2 is a cross-section view of a beaded network cable with round beads according to the present invention.

FIG. 3 is a cross-section view of a beaded network cable with octogonal beads according to the present invention.

FIG. 4 is a cross-section view of a beaded network cable with floret beads according to the present invention.

FIG. 5 is an end view of a beaded network cable with floret beads according to the present invention.

FIG. 6 is a cross-section view of a continuous textured cable casing according to the present invention.

FIG. 7 is an environmental, elevational view showing use of the present invention

Similar reference characters denote corresponding features consistently throughout the attached drawings.

### DETAILED DESCRIPTION OF THE PREFERRED EMBODIMENTS

The present invention is an ornamental computer network cable, designated generally as 10 in the figures. The ornamental computer network cable 10 is used to rapidly visually identify electronic installation cables 20.

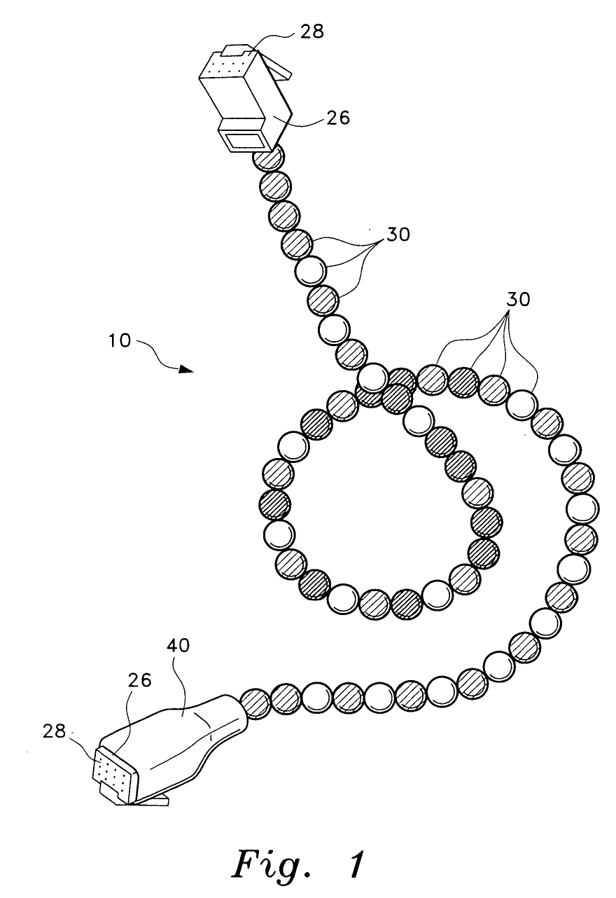

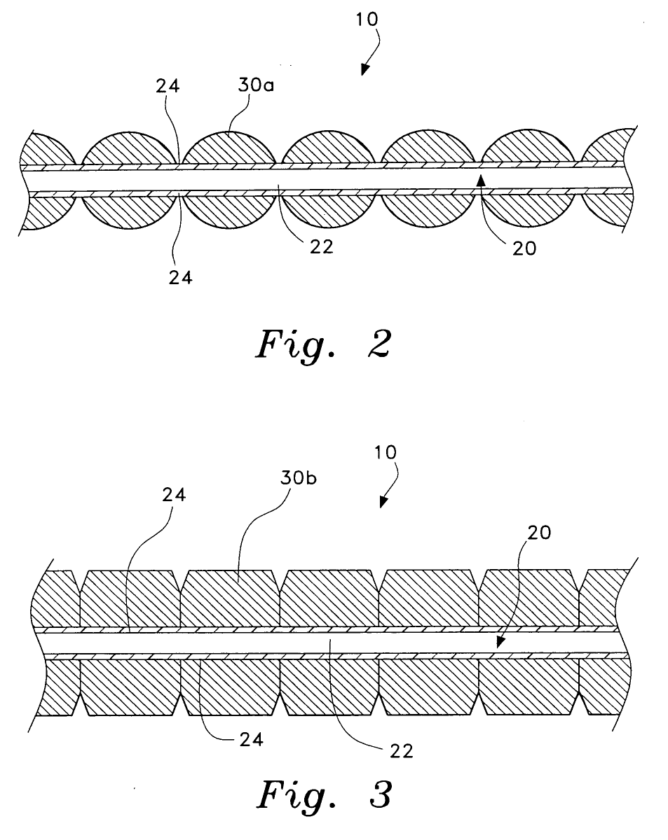

Referring to FIGS. 2-4, the ornamental computer network cable 10 comprises an electronic cable 20, having a data transmission medium 22, an insulating coating 24 surrounding the data transmission medium 22, and connectors 26 secured to each end of the data transmission medium 22. As shown in FIG. 1, the connectors 26 have terminal ends 28 that allow the connectors 26 to relay information to and from the electronic installation 50. The electronic cable 20 may be an Ethernet patch cable, a Telco patch cable, a crossover cable for Ethernet or Telco, a rollover cable, or any other cable type used in a computer or electronic device networking arrangement. The connectors 26 may include RJ-45 and other typical networking cable connectors.

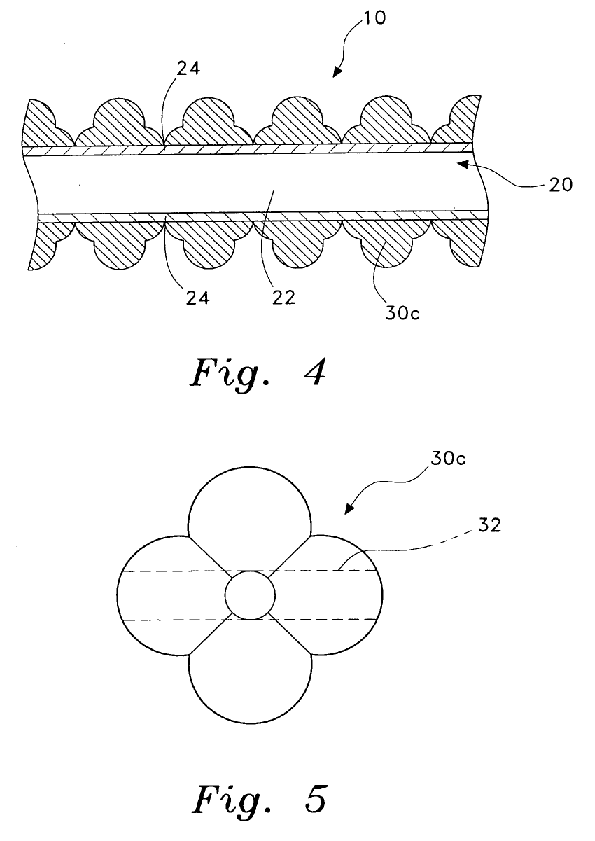

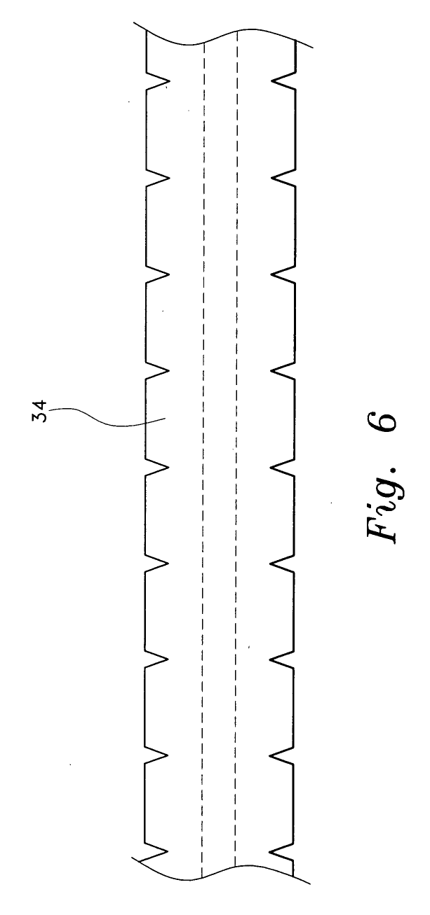

A series of colored, textured beads 30 are disposed along the length of the electronic installation cable 20, as shown in FIGS. 2-4. The color and texture patterns formed by the beads 30 may be used to identify the type of data carried by the cable 20, whether the data is critical to some function, whether the cable 20 is active, the source or owner of the information, and other characteristics. Each bead 30 includes a passage 32, as shown in FIG. 5, extending through the bead 30, to allow the cable 20 to pass through the bead. Each bead 30 has a cross sectional shape that produces a texture that may be viewed and felt by a user. The cross sectional shape may be round, as shown by bead 30A in FIG. 2, octagonal, as shown by bead 30B in FIG. 3, floret-shaped, as shown by bead 30C in FIGS. 4-5, or any other polygonal shape. The floret shape uses at least four conjoined semi-circular arcs in series around the circumference of the bead 30C to create a shape similar to a flower. The beads 30 may be separate, individual pieces, or may be fused together into a solid, colored, textured casing 34, as shown in FIG. 6. The textured casing 34 maintains the flexibility and external appearance of the series of individual beads 30, but uses only one piece to cover the length of the cable 20, or a substantial portion thereof.

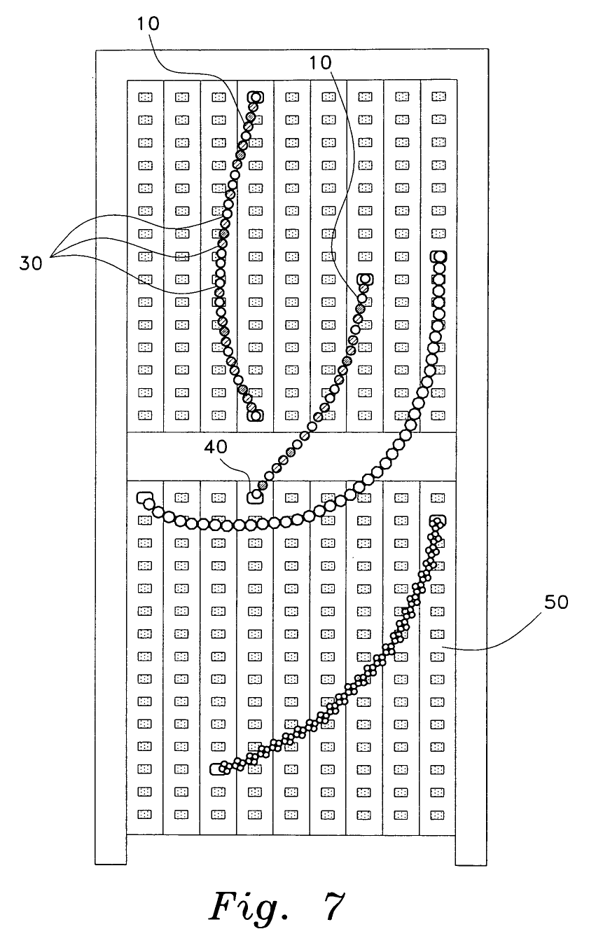

Referring back to FIG. 1, the beads 30 may be arranged about the cable 20 such that the beads 30 form a colored or textured pattern. This pattern may include alternating at least two colors of beads 30, using a specific number of the same color beads 30 at the beginning of the cable 10, using round beads 30 to signify one type of cable 20 and floret beads 30 to signify another type of cable 20. Once the particular identifying patterns are set, all users can quickly and easily identify the relevant characteristics of every cable 10 in an electronic installation 50, as shown in FIG. 7.

Additionally, colored or textured boots 40 may be used, in conjunction with the beads 30, to protect and identify the connectors 26 attached to the end of the cables 20. The boots 40 may be made of a durable insulating material, and may be disposed about the connectors 26, such that the terminal ends 28 may connect into sockets in the electronic installation 50 while the protruding portions of the connectors 26 are protected.

It is to be understood that the present invention is not limited to the embodiments described above, but encompasses any and all embodiments within the scope of the following claims.

1. An ornamental computer network cable, comprising:
an electronics cable, having a data transmission medium, an insulating coating surrounding the data transmission medium, and RJ45-type connectors secured to each end of the data transmission medium, the connectors adapted to allow the data to be transferred from a first electronic device to a second electronic device through the data transmission medium; and
a plurality of beads, each having a passage therethrough, a predetermined cross-sectional shape and a colored appearance, wherein said beads are disposed about the length of said electronics cable in such an arrangement as to form an identifiable pattern in color and texture.

2. The ornamental computer network cable according to claim 1, further comprising protective connector boots disposed about the connectors, said protective connector boots adapted to code-color and prevent damage to the connectors on said ornamental computer network cable.

3. The ornamental computer network cable according to claim 1, wherein said cross-sectional shape is round.

4. The ornamental computer network cable according to claim 1, wherein said cross-sectional shape is octagonal.

5. The ornamental computer network cable according to claim 1, wherein said cross-sectional shape is floret-configured.

6. The ornamental computer network cable according to claim 1, wherein said cross-sectional shape is polygonal.

7. A method for identifying characteristics of a computer network cable, comprising the steps of::
providing a plurality of electronics cables, wherein each cable has a RJ45-type connector at their ends;
providing a plurality of beads, said beads having passages therethrough and a polygonal cross-sectional shape;
passing said electronic cables through the passages in a plurality of said beads, wherein said beads are arranged so as to form a predetermined pattern in color and texture;
repeating the color and texture pattern of said beads on said cables with similar functional characteristics; and
installing said cables in an electronic installation.

8. The method for identifying characteristics of a computer network cable according to claim 7, further comprising covering substantially the entire length of said cables with said beads.

9. The ornamental computer cable according to claim 1, further comprising said beads being disposed substantially along the entire length of said cable.
